(19) United States
(12) Patent Application Publication
(10) Pub. No.: US 2022/0109529 A1
(43) Pub. Date: Apr. 7, 2022

(54) HARQ-ACK INFORMATION DISABLING IN COMMUNICATION SYSTEMS

(71) Applicant: Samsung Electronics Co., Ltd., Suwon-si (KR)

(72) Inventors: Qiaoyang Ye, San Jose, CA (US); Aristides Papasakellariou, Houston, TX (US); Jeongho Jeon, San Jose, CA (US)

(21) Appl. No.: 17/476,221

(22) Filed: Sep. 15, 2021

Related U.S. Application Data
(60) Provisional application No. 63/087,630, filed on Oct. 5, 2020.

(51) Int. Cl. H04L 1/18; H04W 72/12

(52) U.S. Cl. CPC H04L 1/1819; H04W 72/1263; H04W 72/1289; H04L 1/1896

(57) ABSTRACT

Methods and apparatuses for hybrid automatic repeat request acknowledgment (HARQ-ACK) information disabling in communication systems. A method for operating a user equipment includes receiving information for a set of HARQ processes without HARQ-ACK information and transport blocks (TBs). The TBs include a first number of TBs not associated with HARQ processes from the set of HARQ processes and a second number of TBs associated with HARQ processes from the set of HARQ processes. The method further includes determining a HARQ-ACK information codebook for the TBs and a power, for a transmission of a physical uplink control channel (PUCCH) with the HARQ-ACK information codebook, based on the first number of TBs and not based on the second number of TBs. The method further includes transmitting the PUCCH using the power.

### CROSS-REFERENCE TO RELATED APPLICATIONS AND CLAIM OF PRIORITY

The present application claims priority to U.S. Provisional Patent Application No. 63/087,630, filed on Oct. 5, 2020. The contents of the above-identified patent documents are incorporated herein by reference.

### TECHNICAL FIELD

The present disclosure relates generally to wireless communication systems and, more specifically, the present disclosure relates to hybrid automatic repeat request-acknowledgement (HARQ-ACK) information disabling in communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to HARQ-ACK information disabling in communication systems.

In one embodiment, a method for providing HARQ-ACK information is provided. The method includes receiving information for a set of HARQ processes without HARQ-ACK information and transport blocks (TBs). The TBs include a first number of TBs not associated with HARQ processes from the set of HARQ processes and a second number of TBs associated with HARQ processes from the set of HARQ processes. The method further includes determining a HARQ-ACK information codebook for the TBs and a power, for a transmission of a physical uplink control channel (PUCCH) with the HARQ-ACK information codebook, based on the first number of TBs and not based on the second number of TBs. The method further includes transmitting the PUCCH using the power.

In another embodiment, a user equipment (UE) is provided. The UE includes a transceiver configured to receive information for a set of HARQ processes without HARQ-ACK information and transport blocks TBs. The TBs include a first number of TBs not associated with HARQ processes from the set of HARQ processes and a second number of TBs associated with HARQ processes from the set of HARQ processes. The UE further includes a processor operably connected to the transceiver. The processor is configured to determine a HARQ-ACK information codebook for the TBs and a power, for a transmission of a PUCCH with the HARQ-ACK information codebook, based on the first number of TBs and not based on the second number of TBs. The transceiver is further configured to transmit the PUCCH using the power.

In yet another embodiment, a base station is provided. The base station includes a transceiver configured to transmit information for a set of HARQ processes without HARQ-ACK information and TBs. The TBs include a first number of TBs not associated with HARQ processes from the set of HARQ processes and a second number of TBs associated with HARQ processes from the set of HARQ processes. The transceiver is further configured to receive a HARQ-ACK information codebook for the TBs. The base station further includes a processor operably connected to the transceiver. The processor is configured to determine HARQ-ACK information from the HARQ-ACK information codebook. The HARQ-ACK information is only for TBs from the first number of TBs when the HARQ-ACK information codebook is Type-1. The HARQ-ACK information is for the TBs from the first and second number of TBs when the HARQ-ACK information codebook is Type-2.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to this disclosure;

FIG. 6 illustrates a flowchart of a method for disabling of a HARQ-ACK information report and a corresponding DCI format indication according to embodiments of the present disclosure;

FIG. 7 illustrates another flowchart of a method for a configuration for enabling or disabling HARQ-ACK information for corresponding HARQ processes according to embodiments of the present disclosure;

FIG. 8 illustrates a flowchart of a method for a configuration and transmission of Type-1 HARQ-ACK codebook according to embodiments of the present disclosure;

FIG. 9A illustrates an example type-1 HARQ-ACK codebook according to embodiments of the present disclosure; and

FIG. 9B illustrates another type-1 HARQ-ACK codebook according to embodiments of the present disclosure.

### DETAILED DESCRIPTION

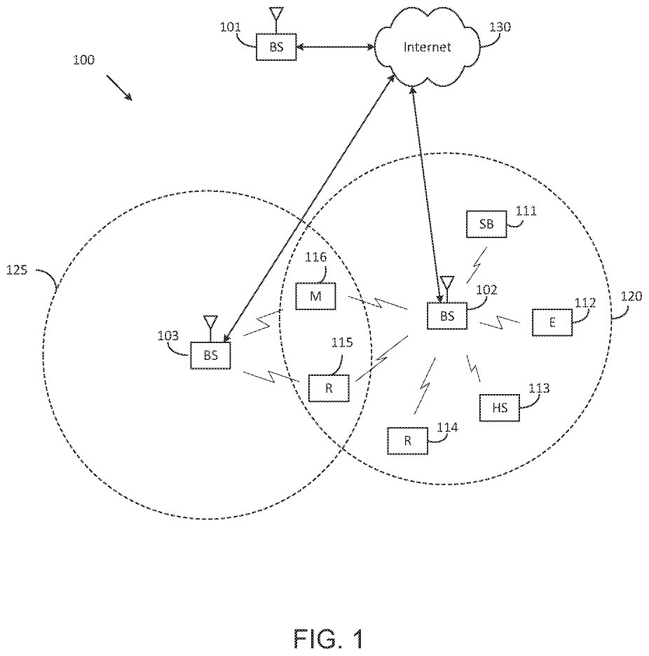

FIG. 1 through FIG. 9B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP, TR 38.811 v15.3.0, “Study on NR to support non-terrestrial networks”; 3GPP, TR 38.821 v16.0.0, “Solutions for NR to support non-terrestrial networks (NTN)”; 3GPP TS 38.212 v16.3.0, “NR; Multiplexing and channel coding”; 3GPP TS 38.213 v16.3.0, “NR; Physical Layer Procedures for Control”; 3GPP TS 38.214 v16.3.0, “NR; Physical Layer Procedures for Data”; 3GPP TS 38.321 v16.2.0, “NR; Medium Access Control (MAC) protocol specification”; and 3GPP TS 38.331 v16.2.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “gNB” can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance etc.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for HARQ-ACK information disabling in a wireless communication system. In certain embodiments, and one or more of the gNBs 101-103 includes circuitry, programing, or a combination thereof, for HARQ-ACK information disabling in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

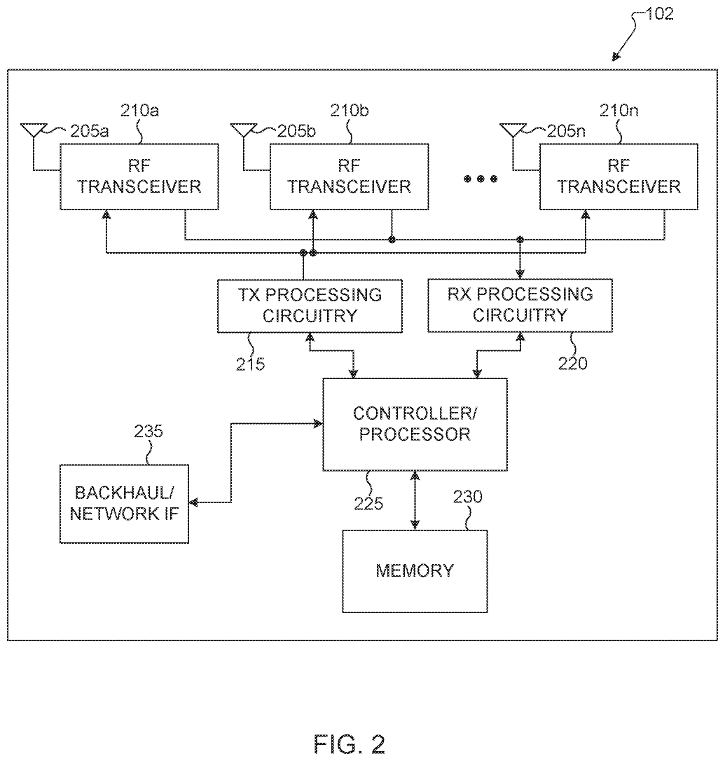

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support HARQ-ACK information disabling in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

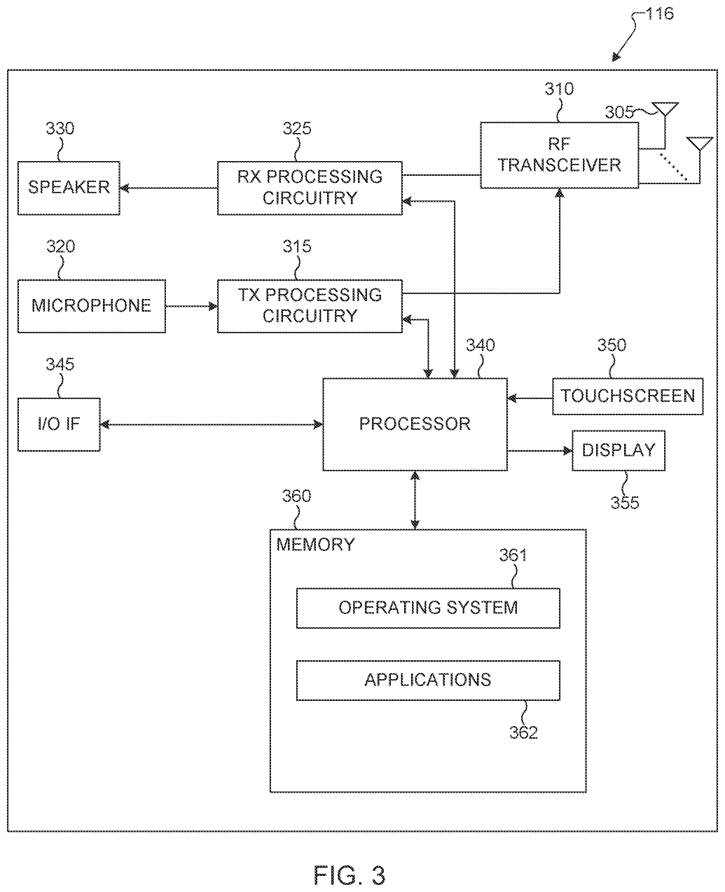

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for HARQ-ACK information disabling in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

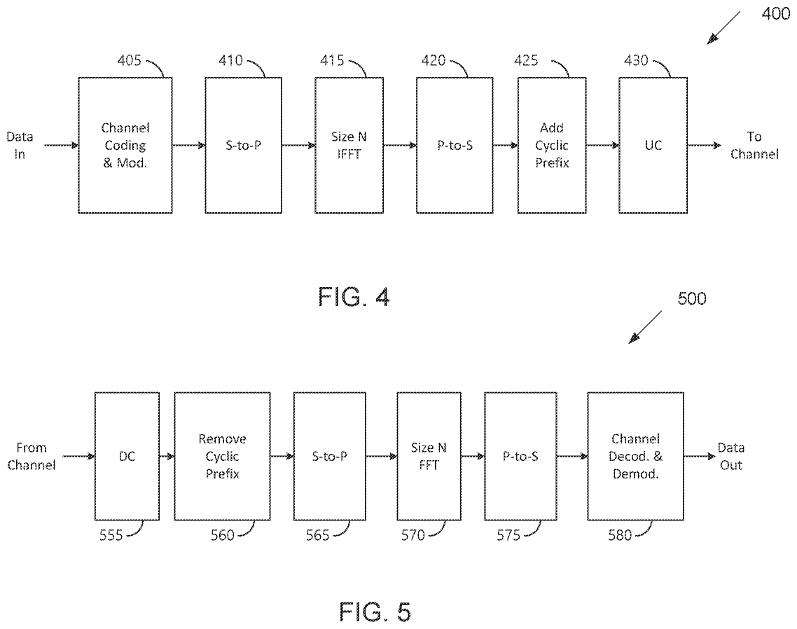

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 400, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective PUSCH or a PUCCH. A PUSCH or a PUCCH can be transmitted over a variable number of slot symbols including one slot symbol. When a UE simultaneously transmits data information and UCI, the UE can multiplex both in a PUSCH or, depending on a UE capability, transmit both a PUSCH with data information and a PUCCH with UCI at least when the transmissions are on different cells.

UCI includes HARQ-ACK information, indicating correct or incorrect detection of data transport blocks (TBs) or of code block groups (CBGs) in a PDSCH, a scheduling request (SR) indicating whether a UE has data in a buffer to transmit, and CSI reports enabling a gNB to select appropriate parameters for PDSCH or PDCCH transmissions to a UE. A CSI report can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, of a CSI-RS resource indicator (CRI) used to obtain the CSI report, and of a rank indicator (RI) indicating a transmission rank for a PDSCH. UL RS includes DMRS and SRS. DMRS is typically transmitted within a BW of a respective PUSCH or PUCCH. A gNB can use a DMRS to demodulate information in a respective PUSCH or PUCCH. SRS is transmitted by a UE to provide a gNB with an UL CSI and, for a TDD system, to also provide a PMI for DL transmission. Further, as part of a random access procedure or for other purposes, a UE can transmit a physical random access channel (PRACH).

DL transmissions and UL transmissions can be based on an OFDM waveform including a variant using DFT precoding that is known as DFT-spread-OFDM.

A non-terrestrial network (NTN) refers to the networks, or segments of networks, using an airborne or space-borne vehicle to embark a transmission equipment relay node or base station. An NTN can provide ubiquitous coverage and is less vulnerable to disasters, compared to conventional terrestrial network. There is increasing interest in support of NTN in narrowband internet of things (NB-IoT), enhanced machine type communication (eMTC), LTE and 5G systems.

Due to the large distance between satellites and UEs, propagation delays in NTN are much larger than in conventional terrestrial networks. In NR systems, the number of HARQ processes is up to 16. Due to the long HARQ round trip time in NTN, there would be HARQ stalling if no enhancement is supported to the conventional HARQ operation. Such an enhancement is HARQ-ACK feedback disabling per HARQ process based on UE-specific RRC signaling.

The present disclosure provides various embodiments associated with disabling an HARQ-ACK information report for a HARQ process corresponding to a PDSCH reception scheduled by DCI format in PDCCH reception or for semi-persistently scheduled (SPS) PDSCH based on a configuration by RRC signaling and possible additional activation/deactivation by a DCI format. In the following, HARQ-ACK information in response to PDSCH receptions is considered for brevity but HARQ-ACK information can also be provided for detection of DCI formats such as a detection of a DCI format indicating a SPS PDSCH release or a DCI format indicating SCell dormancy without scheduling PDSCH as described in TS 38.213 v16.3.0, “NR; Physical Layer Procedures for Control”. Moreover, the disclosure considers enhancements on HARQ-ACK codebook construction and on DCI format design when a HARQ-ACK information report for a HARQ process can be enabled or disabled.

In NR systems, there are three types of codebooks: Type-1, Type-2, and Type-3 HARQ-ACK codebooks.

A Type-1 HARQ-ACK codebook has size that depends on a configured maximum and minimum HARQ timing, a configured number of component carriers (CCs) or cells, and on other parameters as described in TS 38.213 v16.3.0, “NR; Physical Layer Procedures for Control”. A Type-1 HARQ-ACK codebook that considers all possible PDSCH receptions that can have corresponding HARQ-ACK information multiplexed in a same PUCCH transmission would include HARQ-ACK information for HARQ processes with disabled HARQ-ACK information reporting. As an important drawback of a Type-1 HARQ-ACK codebook is a corresponding size, due to inclusion of HARQ-ACK information for all PDSCH receptions with corresponding HARQ-ACK information that can be provided in a same PUCCH, it is beneficial to avoid inclusion of unnecessary HARQ-ACK information. Therefore, there is a need for a corresponding enhancement for a Type-1 HARQ-ACK codebook determination when HARQ-ACK information report for a HARQ process is configured to be disabled.

A Type-2 HARQ-ACK codebook includes HARQ-ACK information only for PDSCH receptions that a UE identifies as scheduled or configured, regardless of whether or not the UE actually receives a PDSCH. That functionality is enabled by a counter downlink assignment index (DAI) and, when applicable such as for operation with DL CA, a total DAI in a DCI format scheduling a PDSCH reception. When a HARQ-ACK information report for a HARQ process is disabled, a UE can ignore the values of the DAI fields in a DCI format with a HARQ process number (HPN) field indicating the HARQ process, and the Type-2 HARQ-ACK codebook can include HARQ-ACK information only for HARQ processes with enabled HARQ-ACK information report. The DAI values can only change/increase when a TB in a subsequent corresponding PDSCH is associated with a HARQ process with enabled HARQ-ACK information report.

A Type-3 HARQ-ACK codebook, also referred to as one-shot codebook, can include HARQ-ACK information for all DL HARQ processes and for all configured DL cells. NDI can be configured as a part of the information provides by a Type-3 HARQ-ACK codebook. A serving gNB can request a UE to provide a Type-3 HARQ-ACK codebook by a DCI format, such as a DCI format 1_1 as described in TS 38.212 v16.3.0, “NR; Multiplexing and channel coding”, and TS 38.213 v16.3.0, “NR; Physical Layer Procedures for Control”. When the DCI format does not schedule a PDSCH reception or a PUSCH transmission and is instead used to request a UE to provide a Type-3 HARQ-ACK codebook, all bits of a frequency domain resource assignment (FDRA) field in the DCI format are set to 0 when a resource allocation type is Type-0 or are set to 1 when a resource allocation type is Type-1 or are set to either 0 or 1 when the DCI format can indicate either resource allocation Type-0 or resource allocation Type-1. A Type-3 HARQ-ACK codebook that considers HARQ-ACK information for all DL HARQ processes and for all configured DL cells would include HARQ-ACK information for HARQ processes with disabled HARQ-ACK information reporting. It is beneficial to avoid inclusion of unnecessary HARQ-ACK information. Therefore, there is a need to enhance a Type-3 HARQ-ACK codebook determination when HARQ-ACK information report for a HARQ process is configured to be disabled.

The present disclosure relates to a communication system. For systems such as NTN, due to the large distance between satellites and UEs, propagation delays are much larger than in conventional terrestrial networks. In NR systems, the number of HARQ processes is up to 16. Due to the long HARQ round trip time in NTN, there would be HARQ stalling if no enhancement is supported to the conventional HARQ operation. Such an enhancement is HARQ-ACK feedback disabling per HARQ process based on UE-specific RRC signaling.

Techniques, apparatus and methods are disclosed for configuration and enhancements for HARQ-ACK information disabling, specifically the detailed configuration method for HARQ-ACK information disabling, and the enhancements for HARQ-ACK codebook and DCI design, that can be applied to scenarios with disabled HARQ-ACK information. The disclosed techniques, apparatus and methods can be applied not only to NTN systems, but also to any other wireless communication systems.

The embodiments of the disclosure are applicable in general to any communication system using a HARQ-ACK information report for a reception of a TB associated with a HARQ process when the HARQ-ACK information report can be enabled or disabled. The examples presented for NTN systems may be considered in inclusive manner, without exclusion of other wireless communication systems.

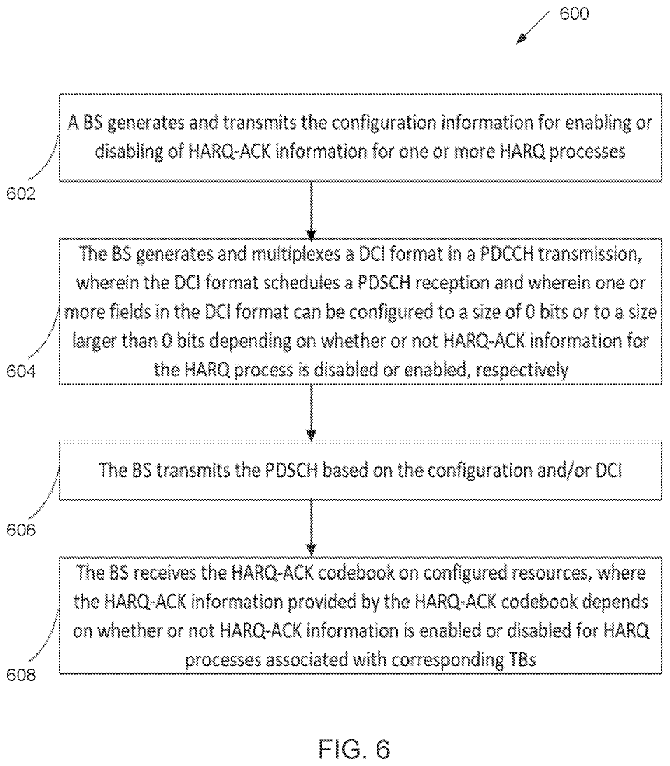

FIG. 6 illustrates a flowchart of a method 600 for disabling of a HARQ-ACK information report and a corresponding DCI format indication according to embodiments of the present disclosure. For example, the method 600 may be implemented by a base station such as gNB 102 in FIG. 1. An embodiment of the method 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

The method 600 includes operations for configuration and indication for a DL transmission where HARQ-ACK feedback can be enabled or disabled. At operation 602, a gNB generates and provides to a UE configuration information for enabling or disabling HARQ-ACK information for one or more HARQ processes. Further, the information can be cell-specific and provided, for example by a system information block, or UE-specific and provided for example by UE-specific RRC signaling or by an indication in a DCI format scheduling a PDSCH reception that includes a TB associated with a HARQ process.

The configuration method is discussed in the following “configuration of HARQ-ACK feedback disabling” section. At operation 604, the gNB generates and multiplexes a DCI format in a PDCCH transmission, wherein the DCI format schedules a PDSCH reception and wherein one or more fields in the DCI format can be configured to a size of 0 bits or to a size larger than 0 bits depending on whether or not HARQ-ACK information for the HARQ process is disabled or enabled, respectively, as is further subsequently discussed in the “enhancement for DCI design” section. The DCI format schedules a PDSCH reception and includes information indicating whether a HARQ-ACK information report for a decoding outcome of a TB associated with HARQ process indicated by the DCI format is enabled or disabled. At operation 606, the gNB transmits the PDSCH that is scheduled by the DCI format. At operation 608, the gNB receives a PUSCH or a PUCCH that provides a HARQ-ACK codebook. The HARQ-ACK information provided by the HARQ-ACK codebook depends on whether or not HARQ-ACK information is enabled or disabled for HARQ processes associated with corresponding TBs as is subsequently described in the “enhancement for HARQ-ACK codebook” section.

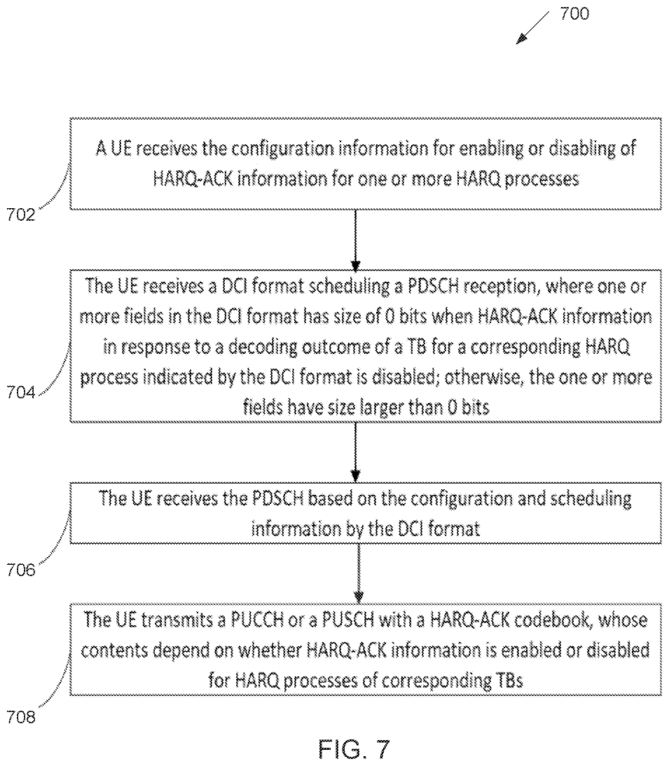

FIG. 7 illustrate another flowchart of a method 700 for a configuration for enabling or disabling HARQ-ACK information for corresponding HARQ processes according to embodiments of the present disclosure. For example, the method 700 may be implemented by a UE such as UE 116 in FIG. 1. An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

The method 700 includes operations for a configuration and indication of HARQ-ACK information enabling or disabling for a corresponding HARQ process. At operation 702, a UE receives the configuration information including the indication of enabling or disabling of HARQ-ACK information for one or more HARQ processes. Further, the indication can be cell-specific or UE-specific as is subsequently described in the “configuration of HARQ-ACK feedback disabling” section. At operation 704, the UE receives a DCI format scheduling a PDSCH reception, where one or more fields in the DCI format has size of 0 bits when HARQ-ACK information in response to a decoding outcome of a TB for a corresponding HARQ process indicated by the DCI format is disabled; otherwise, the one or more fields have size larger than 0 bits as is subsequently described in the “enhancement for DCI design” section. At operation 706, the UE receives the PDSCH based on the configuration and the scheduling information by the DCI format. At operation 708, the UE transmits a PUCCH or a PUSCH with a HARQ-ACK codebook. The contents of the HARQ-ACK codebook depend on whether HARQ-ACK information is enabled or disabled for HARQ processes of corresponding TBs as is subsequently described in the “enhancement for HARQ-ACK codebook” section.

In one embodiment, UE-specific RRC signaling, such as an IE PDSCH-ServingCellConfig or an IE PDSCH-Config in IE BWP-DownlinkDedicated, can include a parameter indicating whether or not HARQ-ACK information can be disabled. The configuration information can be provided by UE-specific RRC signaling and can be common among all configured DL/UL BWPs or can be BWP-specific for example when different BWPs use different sub-carrier spacing (SCS) configurations.

Further, the configuration can be cell-specific for example when a PUCCH with HARQ-ACK information can be transmitted in more than one cell and one cell uses TDD (disabling may apply in order to avoid HARQ stalling) while another cell used FDD (disabling may not apply). The configuration information can be indicated via a bitmap having a one-to-one mapping with configured HARQ processes, such as a length-N bitmap, where for example a bit of 0 value indicates that HARQ-ACK information is enabled and a bit value of 1 indicates that HARQ-ACK information is disabled (or vice versa), and N is the number of configured HARQ processes, such as N=16 or N=32.

Alternatively, a number of HARQ processes with disabled (or enabled) HARQ-ACK information can be continuous and can be configured via a starting index and an ending index and/or number of HARQ processes with disabled HARQ-ACK information. For example, HARQ processes with IDs from N1 to N2 are configured with disabled HARQ-ACK information, where the indication can be via N1 as a starting HARQ process ID and N2 as an ending HARQ process ID, or N1 as a starting HARQ process ID and (N2−N1+1) as a number of HARQ processes with disabled HARQ-ACK information. TABLE 1 shows a PDSCH configuration.

TABLE 1
PDSCH configuration

| PDSCH-ServingCellConfig ::= | | SEQUENCE { |
|---|---|---|
| | codeBlockGroupTransmission | SetupRelease { PDSCH-CodeBlockGroupTransmission } |

OPTIONAL, -- Need M

| | | |
|---|---|---|
| xOverhead | ENUMERATED { xOh6, xOh12, xOh18 } | OPTIONAL, -- Need S |

| ..., | | |
|---|---|---|
| [[ | | |
| maxMIMO-Layers | INTEGER (1..8) | OPTIONAL, -- Need M |

| | | |
|---|---|---|
| processingType2Enabled | BOOLEAN | OPTIONAL -- Need M |

]],
[[
pdsch-CodeBlockGroupTransmissionList-r16 SetupRelease { PDSCH-

CodeBlockGroupTransmissionList-r16 } OPTIONAL -- Need M

| ]] | |
|---|---|
| pdsch-disabledHARQ | CHOICE{ |

| | |
|---|---|
| shortBitmap | BIT String (SIZE (16)), |
| longBitmap | BIT String (SIZE (32)), |

OPTIONAL, -- Cond NTN
}

TABLE 2 shows a PDSCH configuration for disable HARQ.

TABLE 2
IE PDSCH-ServingCellConfig modification for configuration
of HARQ-ACK information disabling

pdsch-disabledHARQ
Indicates the HARQ processes those HARQ-ACK information are
disabled. The first/leftmost bit corresponds to HARQ process
0, the second bit corresponds to HARQ process 1, and so on.
Value 0 in the bitmap indicates that the HARQ-ACK
information for the corresponding HARQ process is enabled.
Value 1 in the bitmap indicates that the HARQ-ACK information
for the corresponding HARQ process is disabled.

In one embodiment, the above configuration methods can apply to a PDSCH reception scheduled by a DCI format. For SPS PDSCH receptions, in a first approach, HARQ-ACK information disabling is not supported. In a second approach, HARQ-ACK information disabling can be configured, for example in IE SPS-Config for a corresponding SPS PDSCH configuration. In a third approach, HARQ-ACK information disabling can be indicated in a DCI format activating the SPS PDSCH receptions. The following HARQ-ACK disabling methods can be considered for SPS PDSCH.

In one example (approach 1), HARQ-ACK information disabling applies to all SPS PDSCH HARQ processes.

In one example (approach 2), HARQ-ACK information for one or more HARQ processes for SPS PDSCH receptions can be disabled, while HARQ-ACK information for the remaining HARQ processes can be enabled. For example, a same HARQ disabling configuration for scheduled PDSCH also applies to SPS PDSCH when a corresponding HARQ process ID is configured with disabled HARQ-ACK information. In a variation of approach 2, the HARQ processes with disabled HARQ-ACK information for SPS PDSCH can be indicated via a bitmap or via a starting HARQ process ID and ending HARQ process ID/number of disabled HARQ processes as a part of SPS PDSCH configuration, such as in IE SPS-Config.

In one example (approach 3), HARQ information for SPS PDSCH can be disabled for a subset of the HARQ processes per SPS configuration or per SPS configuration. The subset of disabled HARQ processes can be predefined or can be the M HARQ processes with larger IDs from a total of HARQ processes, where parameter M and N can be predefined, or can be configured by higher layers via UE-specific RRC signaling, for example as part of the SPS configuration.

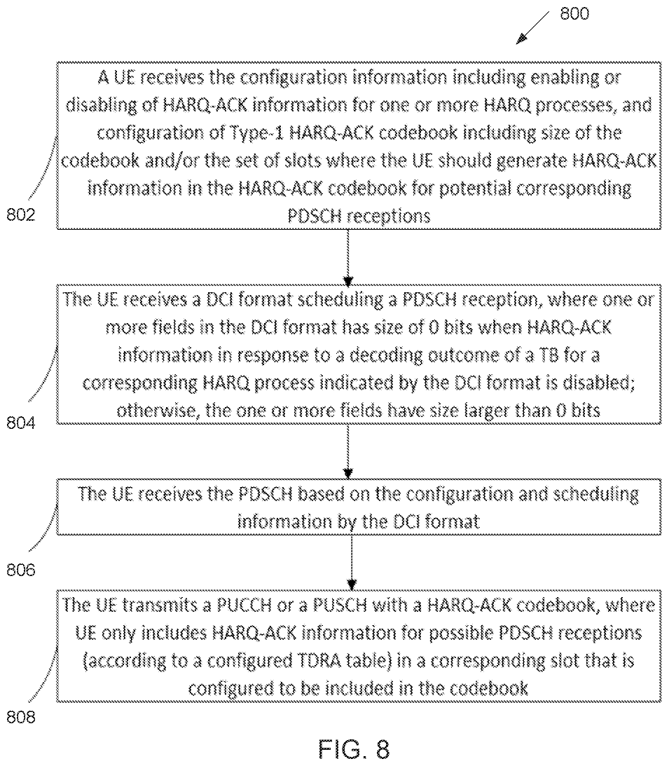

FIG. 8 illustrates a flowchart of a method 800 for a configuration and transmission of Type-1 HARQ-ACK codebook according to embodiments of the present disclosure. For example, the method 800 may be implemented by a UE such as UE 116 in FIG. 1. An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

For Type-1 HARQ-ACK codebook, in one embodiment, a maximum codebook size can be configured.

As illustrated in FIG. 8, at operation 802, a UE receives the configuration information for enabling or disabling HARQ-ACK information for one or more HARQ processes, and the configuration information for Type-1 HARQ-ACK codebook. The configuration of Type-1 HARQ-ACK codebook can include the configuration for the size of the codebook and/or the set of slots where the UE may generate HARQ-ACK information in the HARQ-ACK codebook for potential corresponding PDSCH receptions. The configuration information can be indicated by cell-specific RRC signaling, such as by a MIB, SIB1 or other SIBS, or by UE-specific RRC signaling, such as a part of PUCCH-config and/or PUSCH-config.

At operation 804, the UE receives a DCI format scheduling a PDSCH reception, where one or more fields in the DCI format associated with HARQ-ACK reporting has size of 0 bits when HARQ-ACK information in response to a decoding outcome of a TBS for a corresponding HARQ process indicated by the DCI format is disabled; otherwise, the one or more fields have size larger than 0 bits as is subsequently described in the “enhancement for DCI design” section. At operation 806, the UE receives the PDSCH based on the configuration and the scheduling information by the DCI format. At operation 808, the UE transmits a PUCCH or a PUSCH with a HARQ-ACK codebook. The contents of the HARQ-ACK codebook depend on whether HARQ-ACK information is enabled or disabled for HARQ processes of corresponding TBs. Specifically, the UE only includes the HARQ-ACK information for possible PDSCH receptions (according to a configured TDRA table) in a corresponding slot that is configured to be included in the codebook.

In one example (approach 1-1), denoting by M a maximum size of Type-1 HARQ-ACK codebook resulting based on configurations as described in TS 38.213 v16.3.0, “NR; Physical Layer Procedures for Control”, a size K can be configured when one or more HARQ processes are configured with disabled HARQ-ACK information. The configuration of parameter K can be indicated by cell-specific signaling, e.g., MIB, SIB1 or other SIBS, or UE-specific RRC signaling, for example as a part of PUCCH-config and/or PUSCH-config. When a size of Type-1 HARQ-ACK codebook, as determined based on the procedure in TS 38.213 v16.3.0, “NR; Physical Layer Procedures for Control”, exceeds K, the UE suspends further generation of HARQ-ACK information bits to include in the Type-1 HARQ-ACK codebook. Further, the slots for which the UE generates HARQ-ACK information bits to include in the Type-1 HARQ-ACK codebook can be predefined or can be configured by UE-specific or UE-common RRC signaling.

In one example (approach 1-2), a UE can be provided by higher layers a bitmap for a Type-1 HARQ-ACK codebook, wherein the bitmap indicates slots where the UE may generate HARQ-ACK information in the HARQ-ACK codebook for potential corresponding PDSCH receptions. The bitmap configuration can be indicated by cell-specific RRC signaling, such as by a MIB, SIB1 or other SIBS, or by UE-specific RRC signaling, such as a part of PUCCH-config and/or PUSCH-config.

For example, a length of the bitmap can be equal to a maximum number of slots that the UE can generate HARQ-ACK information for Type-1 HARQ-ACK codebook, wherein the maximum number of slots can be determined based a set of slot timing values for HARQ-ACK information reporting and on a configured TDD UL/DL configuration. For example, a bit value “0” in the bitmap can indicate that HARQ-ACK information for possible PDSCH receptions (according to a configured TDRA table) in a corresponding slot is included in the HARQ-ACK information, while a bit value of “1” indicates that such corresponding HARQ-ACK information is not included (or vice versa).

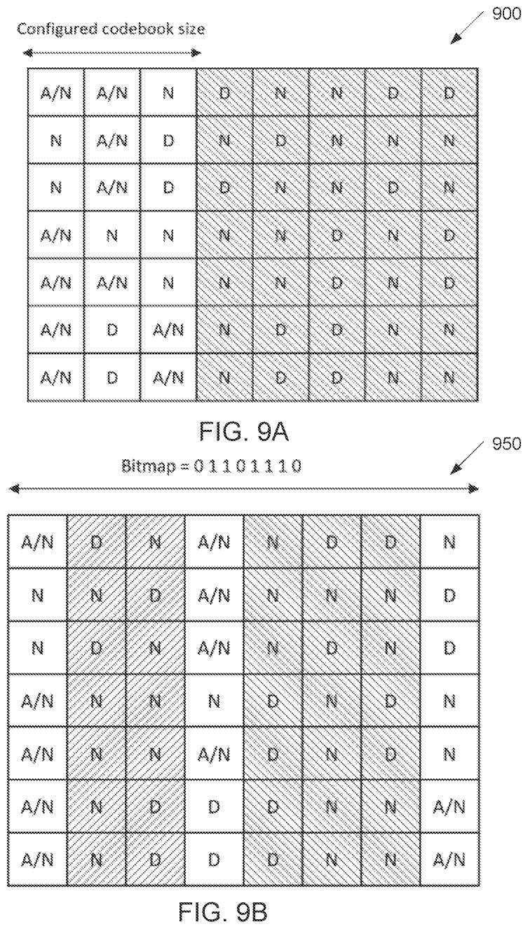

FIG. 9A illustrates an example type-1 HARQ-ACK codebook 900 according to embodiments of the present disclosure. An embodiment of the type-1 HARQ-ACK codebook 900 shown in FIG. 9A is for illustration only. In FIG. 9A, a time-domain size of Type-1 HARQ-ACK codebook is configured, e.g., to 3.

FIG. 9B illustrates another type-1 HARQ-ACK codebook 950 according to embodiments of the present disclosure. An embodiment of the type-1 HARQ-ACK codebook 950 shown in FIG. 9B is for illustration only. In FIG. 9B, a bitmap is used to indicate which slot(s) to be included in the HARQ-ACK codebook.

FIGS. 9A and 9B illustrate Type-1 HARQ-ACK codebook enhancements, where A/N corresponds to HARQ processes with enabled HARQ-ACK information, D corresponds to HARQ processes with disabled HARQ-ACK information, and N corresponds to no scheduling of PDSCH. The blocks in shadow are not included in the HARQ-ACK codebook.

For a Type-3 HARQ-ACK codebook (e.g., approach 1), a UE can report HARQ-ACK information with a predetermined value, such as a NACK value, for HARQ processes with disabled HARQ-ACK information, while the codebook size can remain independent of whether there is enabling or disabling of HARQ processes and include HARQ-ACK information for all HARQ processes. Alternatively, in a second approach, the HARQ-ACK information in a Type-3 HARQ-ACK codebook can include only HARQ-ACK information for HARQ processes with enabled HARQ-ACK information, at least when the configuration of such HARQ processes is predetermined or by higher layer signaling, that is, at least when enabling/disabling of HARQ-ACK information for a HARQ process is not based on a DCI format scheduling a PDSCH reception for the HARQ process.

In one example (approach 3-1), disabling of HARQ-ACK information for each HARQ process is configured by higher layers. A size of a Type-3 HARQ-ACK codebook is determined to be the same as a number of HARQ processes with enabled HARQ-ACK information based on the configuration by higher layers, such as in a system information block or by UE-specific RRC signaling.

In one example, (approach 3-2), disabling of HARQ-ACK information for a HARQ process can be indicated to a UE by a DCI format scheduling a corresponding PDSCH reception with a TB for the HARQ process. The HARQ-ACK information disabling indication by the DCI format can be applicable only for HARQ processes that are not configured HARQ-ACK information disabling by RRC signaling. In one example, the DCI format triggering the UE to report a Type-3 HARQ-ACK codebook can include an indication of the HARQ processes with HARQ-ACK information to be included in the HARQ-ACK codebook. For example, a DCI format 1_1 can trigger the UE to report a Type-3 HARQ-ACK codebook without scheduling a PDSCH reception and then several fields in the DCI format such as for a modulation and coding scheme, VRB-to-PRB mapping, new data indicator, redundancy version, and HARQ process number do not provide any valid information.

Some or all of such fields and be partially or fully used to indicate the HARQ-ACK processes with HARQ-ACK information to be included in the Type-3 HARQ-ACK codebook. In one example, a bitmap can be used when the number of configured HARQ processes is not larger than the number of bits in the DCI format that can be used for the bitmap.

In another example, if there are N HARQ processes and the bitmap size is M<N, the first N−└N/M┘·M bits of the bitmap can indicate reporting of HARQ-ACK information for the first ┌N/M┐·└N−/M┘·M) HARQ processes, and the last M−N+└N/M┘·M bits of the bitmap can indicate reporting of HARQ-ACK information for the last N−┌N/M┐·(N−└N/M┘·M) HARQ processes. For example, for the first N−└N/M┘·M bits of the bitmap, each of these bits can be used to indicate the disabling or enabling of HARQ-ACK information for every ┌N/M┐ HARQ-ACK processes.

In yet another example, HARQ-ACK information is reported in a Type-3 HARQ-ACK codebook for a set of HARQ processes with successive IDs, where the starting ID and the ending ID, or the number of HARQ processes, can be indicated by the some of the fields in the DCI format that do not provide valid information.

In one example (approach 3-3), DAI fields as for Type-2 HARQ-ACK codebook can be used to determine a Type-3 HARQ-ACK codebook, where a counter DAI field indicates a number of scheduled PDSCH receptions with enabled HARQ-ACK information until the UE receives the DCI format triggering the Type-3 HARQ-ACK codebook reporting. When a total DAI field exists in the DCI format, the total DAI field indicates a total number of PDSCH receptions with enabled HARQ-ACK information across all carriers until the reception of the DCI format triggering the Type-3 HARQ-ACK codebook reporting. The DAI fields in the DCI format triggering the Type-3 HARQ-ACK codebook reporting can have same values as in a last DCI format scheduling a PDSCH reception that the UE reports corresponding HARQ-ACK information in the Type-3 HARQ-ACK codebook, wherein the last DCI format is determined as described in TS 38.213 v16.3.0, “NR; Physical Layer Procedures for Control”.

If a UE is scheduled a PDSCH reception for a HARQ process with disabled HARQ-ACK information and the HARQ-ACK information is to be included in a HARQ-ACK codebook that is multiplexed in a PUCCH transmission, the following approaches can be used at least for a Type-1 HARQ-ACK codebook, or for a Type-3 HARQ-ACK codebook when the disabling of HARQ-ACK information for a HARQ process is indicated by a DCI format.

In one example (approach 4), a UE can report a predetermined HARQ-ACK information value, such as a NACK, for the HARQ process with disabled HARQ-ACK information in the HARQ-ACK codebook. This approach can be beneficial, and be further condition to, for HARQ-ACK codebook size O_{ACK} that is 3≤O_{ACK}≤11 because a Reed-Mueller code is then used for encoding the HARQ-ACK information and the decoder can improve detection performance for the HARQ-ACK codebook when some of the HARQ-ACK information bits have a known value. When O_{ACK}<3 and the HARQ-ACK information bits are for disabled HARQ processes, the UE may not transmit a PUCCH with the HARQ-ACK information.

In one example (approach 5), a UE can report HARQ-ACK information based on a reception outcome of a corresponding TB. This may help gNB to perform link adaptation, for example by determining a ratio of NACK values to ACK values that is typically used for open loop link adaptation. This approach can be beneficial, and be further condition to, for HARQ-ACK codebook size O_{ACK} that is O_{ACK}>11 because a polar code is then used for encoding the HARQ-ACK information bits and there is no benefit in decoding reliability of a HARQ-ACK codebook when using predetermined values for some HARQ-ACK information bits. It is also possible to apply approach 5 regardless of the HARQ-ACK codebook size. It is also possible to apply approach 5 when HARQ-ACK information is jointly coded with SR or CSI, at least when a total payload is larger than 11 bits.

When a value of HARQ-ACK information for a HARQ process with disabled HARQ-ACK information reporting is set to a predetermined value, such as a NACK, and for a PUCCH transmission using PUCCH format 2 or PUCCH format 3 or PUCCH format 4, and for a number of UCI bits smaller than or equal to 11, the parameter Δ_{TF,b,f,c}(i) as defined in 38.213 v16.3.0, “NR; Physical Layer Procedures for Control”, for determining a PUCCH transmission power adjustment component on active UL BWP b of carrier f of primary cell c can be calculated by Δ_{TF,b,f,c}(i)=10 log₁₀(K₁−(n_{HARQ-ACK}(i)+O_{SR}(i)+O_{CSI}(i))/N_{RE}(i)) where n_{HARQ-ACK}(i) is a number of HARQ-ACK information bits that the UE determines as described in 38.213 v16.3.0, “NR; Physical Layer Procedures for Control”, for example, excluding the HARQ-ACK information bits corresponding to HARQ processes with disabled HARQ-ACK information in the HARQ-ACK codebook. In other words, a number of HARQ-ACK information bits used for determining a PUCCH transmission power considers only HARQ-ACK information corresponding to HARQ-ACK processes with enabled HARQ-ACK information that the UE includes in the codebook.

For example, the number of HARQ-ACK information bits for Type-1 HARQ-ACK codebook, when O_{ACK}+O_{SR}+O_{CSI}≤11, can be obtained as follows: n_{HARQ-ACK}=Σ_{c=0}^{N}^{_{cells}}^{^{DL}}⁻¹Σₘ₌₀^{M}^{_{c}}⁻¹N_{m,c}^{received}+Σ_{c=0}^{N}^{_{cells}}^{^{DL}}⁻¹Σₘ₌₀^{M}^{_{c}}⁻¹N_{m,c}^{received,CBG}, where: (1) N_{m,c}^{received} is the number of transport blocks the UE receives in PDSCH reception occasion m for serving cell c if harq-ACK-SpatialBundlingPUCCH and PDSCH-CodeBlockGroupTransmission are not provided, or the number of transport blocks the UE receives in PDSCH reception occasion m for serving cell c if PDSCH-CodeBlockGroupTransmission is provided and the PDSCH reception is scheduled by a DCI format 1_0, or the number of PDSCH receptions if harq-ACK-SpatialBundlingPUCCH is provided or SPS PDSCH release in PDSCH reception occasion m for serving cell c, and the HARQ-ACK information is enabled for the HARQ processes corresponding to these transport blocks, and the UE reports corresponding HARQ-ACK information in the PUCCH; and (2) N_{m,c}^{received,CBG} is the number of CBGs the UE receives in a PDSCH reception occasion m for serving cell c if PDSCH-CodeBlockGroupTransmission is provided and the PDSCH reception is scheduled by a DCI format 1_1 and the HARQ-ACK information is enabled for the HARQ processes corresponding to these CBGs and the UE reports corresponding HARQ-ACK information in the PUCCH. In an alternative formulation, N_{m,c}^{received} or N_{m,c}^{received,CBG} is a difference between a total number of TBs or CBGs that a UE provides HARQ-ACK information in a PUCCH and the number of TBs or CBGs corresponding to HARQ processes with disabled HARQ-ACK reports for which the UE sets a corresponding HARQ-ACK bit to a predetermined value such as a value corresponding to a NACK.

When HARQ information for a HARQ process is disabled, a DCI format scheduling the PDSCH reception with the TB corresponding to the HARQ process has several fields associated with HARQ-ACK information reporting that become invalid or have an omitted functionality and can be omitted from the DCI format, such as the counter DAI (for Type-2 codebook) field, the total DAI field when it is configured in the DCI format for HARQ-ACK information reporting, a TPC field for adjusting a power of a PUCCH transmission with HARQ-ACK information, a PUCCH resource indication field for the PUCCH transmission, and/or PDSCH-to-HARQ feedback timing indicator field for the PUCCH transmission timing.

In one embodiment, one or more of fields with configurable number of bits in a DCI format, such as a bandwidth part (BWP) indicator field, a SRS request field, a ZP CSI-RS trigger field can have a size of 0 bits when the DCI format schedules a PDSCH reception with a TB corresponding to a HARQ process with enabled HARQ-ACK information, while the BWP indicator field, SRS request field, and/or ZP CSI-RS trigger field can be configured to have a non-zero size when the DCI format schedules a PDSCH reception with a TB corresponding to a HARQ process with disabled HARQ-ACK information.

Conversely, the DAI fields (for Type-2 codebook), when configured, the TPC field for determining a PUCCH transmission power, the PUCCH resource indication field, and/or the PDSCH-to-HARQ feedback timing indicator field can have a size of 0 bits when the DCI format schedules a PDSCH reception with a TB corresponding to a HARQ process with disabled HARQ-ACK information and have a size larger than 0 bits when the DCI format schedules a PDSCH reception with a TB corresponding to a HARQ process with enabled HARQ-ACK information. A motivation of the above design is to maintain a same size of the DCI format, regardless of whether HARQ-ACK information is enabled or disabled for a corresponding HARQ process, while avoiding an unnecessary increase in the DCI format size due to inclusion of redundant bits.

In one embodiment, a new DCI format can be introduced for scheduling a PDSCH reception with a TB corresponding to a HARQ process with disabled HARQ-ACK information. The new DCI format can have part of or one or more of the DAI (for Type-2 codebook) field, TPC field, PUCCH resource indication field, and/or PDSCH-to-HARQ feedback timing indicator field to be configured to have a size of 0 bits, while remaining bits, if any, in these fields can be set to a default value (e.g., all “0s”). The size of the new DCI format can be also matched, when needed in order to maintain a total number of sizes for DCI formats with CRC scrambled with C-RNTI to 3, to the size of another DCI format, such as the DCI format 0_0/1_0, 0_1 or 0_2.

In one embodiment, enabling or disabling of HARQ-ACK information for a decoding outcome of a TB corresponding to a HARQ process can be indicated by the DCI format scheduling the PDSCH reception that provides the TB. For example, a value for one or more fields in the DCI format can be set to a predefined value. For example, one or more values (e.g., all “0s” or all “1s”) can be defined or configured for one or more of the DAI (for Type-2 codebook) fields, the TPC field for determining a PUCCH transmission power, the PUCCH resource indication field, and/or the PDSCH-to-HARQ feedback timing indicator field to indicate the disabling of HARQ-ACK information for the HARQ process.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for providing hybrid automatic repeat request acknowledgment (HARQ-ACK) information, the method comprising:
receiving:
information for a set of HARQ processes without HARQ-ACK information, and
transport blocks (TBs), wherein the TBs include:
a first number of TBs not associated with HARQ processes from the set of HARQ processes, and
a second number of TBs associated with HARQ processes from the set of HARQ processes; and
determining:
a HARQ-ACK information codebook for the TBs, and
a power, for a transmission of a physical uplink control channel (PUCCH) with the HARQ-ACK information codebook, based on the first number of TBs and not based on the second number of TBs; and
transmitting the PUCCH using the power.

2. The method of claim 1, wherein HARQ-ACK information for the second number of TBs is not included in the HARQ-ACK information codebook.

3. The method of claim 1, wherein:
HARQ-ACK information for the second number of TBs is included in the HARQ-ACK information codebook, and
HARQ-ACK information for any TB from the second number of TBs has a predetermined value.

4. The method of claim 3, wherein:
the HARQ-ACK information codebook is Type-1, and
the HARQ-ACK information codebook includes less than 12 bits.

5. The method of claim 1, wherein:
the first number is zero, and
the power is zero.

6. The method of claim 1, further comprising:
receiving a downlink control information (DCI) format scheduling a reception of a TB from the TBs, wherein:
the DCI format indicates a HARQ process for the TB,
the HARQ process for the TB is not included in the information for the set of HARQ processes, and
the DCI format indicates whether the HARQ process for the TB is included in the set of HARQ processes.

7. The method of claim 1, further comprising:
receiving a downlink control information (DCI) format scheduling a reception of a TB from the TBs, wherein:
the DCI format includes a first field indicating a HARQ process for the TB,
the DCI format includes a second field indicating a slot for the PUCCH transmission with the HARQ-ACK information codebook when the HARQ process is not from the set of HARQ processes, and
the DCI format does not include the second field when the HARQ process is from the set of HARQ processes.

8. The method of claim 1, further comprising:
receiving a downlink control information (DCI) format scheduling a reception of a TB from the TBs, wherein:
the DCI format includes a first field indicating a HARQ process for the TB,
the DCI format includes a second field indicating a resource for the PUCCH transmission with the HARQ-ACK information codebook when the HARQ process is not from the set of HARQ processes, and
the DCI format does not include the second field when the HARQ process is from the set of HARQ processes.

9. A user equipment (UE), comprising:
a transceiver configured to receive:
information for a set of hybrid automatic repeat request (HARQ) processes without HARQ acknowledgment (HARQ-ACK) information, and
transport blocks (TBs), wherein the TBs include:
a first number of TBs not associated with HARQ processes from the set of HARQ processes, and
a second number of TBs associated with HARQ processes from the set of HARQ processes; and
a processor operably connected to the transceiver, the processor configured to determine:
a HARQ-ACK information codebook for the TBs, and
a power, for a transmission of a physical uplink control channel (PUCCH) with the HARQ-ACK information codebook, based on the first number of TBs and not based on the second number of TBs,
wherein the transceiver is further configured to transmit the PUCCH using the power.

10. The UE of claim 9, wherein HARQ-ACK information for the second number of TBs is not included in the HARQ-ACK information codebook.

11. The UE of claim 9, wherein:
HARQ-ACK information for the second number of TBs is included in the HARQ-ACK information codebook, and
HARQ-ACK information for any TB from the second number of TBs has a predetermined value.

12. The UE of claim 11, wherein:
the HARQ-ACK information codebook is Type-1, and
the HARQ-ACK information codebook includes less than 12 bits.

13. The UE of claim 9, wherein:
the first number is zero, and
the power is zero.

14. The UE of claim 9, wherein:
the transceiver is further configured to receive a downlink control information (DCI) format scheduling a reception of a TB from the TBs,
the DCI format indicates a HARQ process for the TB,
the HARQ process for the TB is not included in the information for the set of HARQ processes, and
the DCI format indicates whether the HARQ process for the TB is included in the set of HARQ processes.

15. The UE of claim 9, wherein:
the transceiver is further configured to receive a downlink control information (DCI) format scheduling a reception of a TB from the TBs,
the DCI format includes a first field indicating a HARQ process for the TB,
the DCI format includes a second field indicating a slot for the PUCCH transmission with the HARQ-ACK information codebook when the HARQ process is not from the set of HARQ processes, and
the DCI format does not include the second field when the HARQ process is from the set of HARQ processes.

16. The UE of claim 9, wherein:
the transceiver is further configured to receive a downlink control information (DCI) format scheduling a reception of a TB from the TBs,
the DCI format includes a first field indicating a HARQ process for the TB,
the DCI format includes a second field indicating a resource for the PUCCH transmission with the HARQ-ACK information codebook when the HARQ process is not from the set of HARQ processes, and
the DCI format does not include the second field when the HARQ process is from the set of HARQ processes.

17. A base station, comprising:
a transceiver configured to:
transmit:
information for a set of hybrid automatic repeat request (HARQ) processes without HARQ acknowledgment (HARQ-ACK) information, and
transport blocks (TBs), wherein the TBs include:
a first number of TBs not associated with HARQ processes from the set of HARQ processes, and
a second number of TBs associated with HARQ processes from the set of HARQ processes; and
receive a HARQ-ACK information codebook for the TBs; and
a processor operably connected to the transceiver, the processor configured to determine HARQ-ACK information from the HARQ-ACK information codebook, wherein:
the HARQ-ACK information is only for TBs from the first number of TBs when the HARQ-ACK information codebook is Type-1, and
the HARQ-ACK information is for the TBs from the first and second number of TBs when the HARQ-ACK information codebook is Type-2.

18. The base station of claim 17, wherein:
the transceiver is further configured to transmit a downlink control information (DCI) format scheduling a transmission of a TB from the TBs,
the DCI format indicates a HARQ process for the TB,
the HARQ process for the TB is not included in the information for the set of HARQ processes, and
the DCI format indicates whether the HARQ process for the TB is included in the set of HARQ processes.

19. The base station of claim 17, wherein:
the transceiver is further configured to transmit a downlink control information (DCI) format scheduling a transmission of a TB from the TBs,
the DCI format includes a first field indicating a HARQ process for the TB,
the DCI format includes a second field indicating a slot for a PUCCH reception with the HARQ-ACK information codebook when the HARQ process is not from the set of HARQ processes, and
the DCI format does not include the second field when the HARQ process is from the set of HARQ processes.

20. The base station of claim 17, wherein:
the transceiver is further configured to transmit a downlink control information (DCI) format scheduling a transmission of a TB from the TBs,
the DCI format includes a first field indicating a HARQ process for the TB,
the DCI format includes a second field indicating a resource for a PUCCH reception with the HARQ-ACK information codebook when the HARQ process is not from the set of HARQ processes, and
the DCI format does not include the second field when the HARQ process is from the set of HARQ processes.
